(19) United States
(12) Patent Application Publication
(10) Pub. No.: US 2005/0233775 A1
(43) Pub. Date: Oct. 20, 2005

(54) Mobile phone providing religious prayers and method for the same

(76) Inventor: Jia-Rong Chang, Hsin Chu City (TW)

Correspondence Address: BIRCH STEWART KOLASCH & BIRCH, PO BOX 747, FALLS CHURCH, VA, 22040-0747, US

(21) Appl. No.: 10/825,429

(22) Filed: Apr. 16, 2004

(51) Int. Cl. H04M 1/00; H04B 1/38

(52) U.S. Cl. 455/567; 455/550.1

(57) ABSTRACT

A mobile phone provides religious prayers and has a memory module, a voice module, a display module, a processing module, and an interface module. The memory module stores at least one set of prayer voice data and at least one set of religious text data. The processing module retrieves the prayer voice data and the religious text data from the memory module and plays them through the voice module and/or the display module. The user can also use the interface module to set the processing module to play the prayer voice data or the religious text data, and to set the prayer voice data for ring tone of the mobile phone.

### FIELD OF THE INVENTION

The present invention relates to a mobile phone providing religious prayers and, more particularly, to a mobile phone integrating prayer voice data or religious text data for playing at any time.

### BACKGROUND OF THE INVENTION

The modern communications industry is characterized by quick development, large scale and open market. In particular, wireless communications possesses a large share of the market, and thus brings about potential and considerable business opportunities. Mobile phones have become inevitable articles in everyday lives of modern people. Businessmen, students or common people rely on mobile phones as important tools for communicating with other people.

In addition to the basic function of communicating with other people, present mobile phones have also the functions of incoming call alarm, incoming call vibration, receiving/transmitting text messages, or internet access through the wireless application protocol (WAP). For the incoming call alarm, the mobile phone can change the ring based on the incoming call alarm to be, for example, harmonic rings or multi-stage rings to emphasize personalized features.

Most adherents of a religion can't observe their religion when they are outside or don't bring religious texts with them. Common religious texts (e.g., the Bible) are too heavy and too inconvenient for people to carry. Although small scripture-chanting machines are available, they can be only used in special spaces like temples and hospitals. One generally does not carry a small scripture-chanting machine. If religious texts or religious prayers can be integrated in a mobile phone, the function and value of the mobile phone can be greatly enhanced.

### SUMMARY OF THE INVENTION

One object of the present invention is to propose a mobile phone providing religious prayers, which integrates religious text data or religious prayers therein to help adherents of a religion.

To achieve the above object, the present invention provides a mobile phone providing religious prayers. The mobile phone at least comprises a memory module, a voice module, a display module and a processing module. The memory module stores at least one prayer voice data and at least one religious text data. The processing module retrieves the prayer voice data and the religious text data from the memory module and plays and/or displays them through the voice module and/or the display module, thereby accomplishing the effect of playing or displaying religious prayers at any time.

The present invention also provides a method of playing religious prayers for a mobile phone. First, a menu having a religious prayers item is entered. At least one prayer voice data for playing is then selected. Next, the selected prayer voice data is retrieved. Finally, the prayer voice data is played. The effect of using the mobile phone to play a religious prayers can thus be accomplished.

The present invention also provides a method of displaying a religious prayers on a mobile phone. First, a menu having a religious prayers item is entered. At least one religious text data for displaying is then selected. Next, the selected religious text data is retrieved. Finally, the religious text data is displayed through operations of a user. The effect of using the mobile phone to display a religious prayers can thus be accomplished.

The present invention also provides a method of providing a religious prayers ring tone for a mobile phone. First, a menu having a religious prayers ring tone item is entered. At least one prayer voice data for playing is then selected. Next, a stand-by state is entered. The selected prayer voice data is retrieved and played when the mobile phone has an incoming call. The effect of using religious prayers as ring tones can thus be accomplished.

### BRIEF DESCRIPTION OF THE DRAWINGS

The various objects and advantages of the present invention will be more readily understood from the following detailed description when read in conjunction with the appended drawings, in which:

FIG. 1 is a architecture block diagram of the present invention;

FIG. 2 is a flowchart of a first embodiment of the present invention;

FIG. 3 is a flowchart of a second embodiment of the present invention; and

FIG. 4 is a flowchart of a third embodiment of the present invention;

### DETAILED DESCRIPTION OF THE PREFERRED EMBODIMENTS

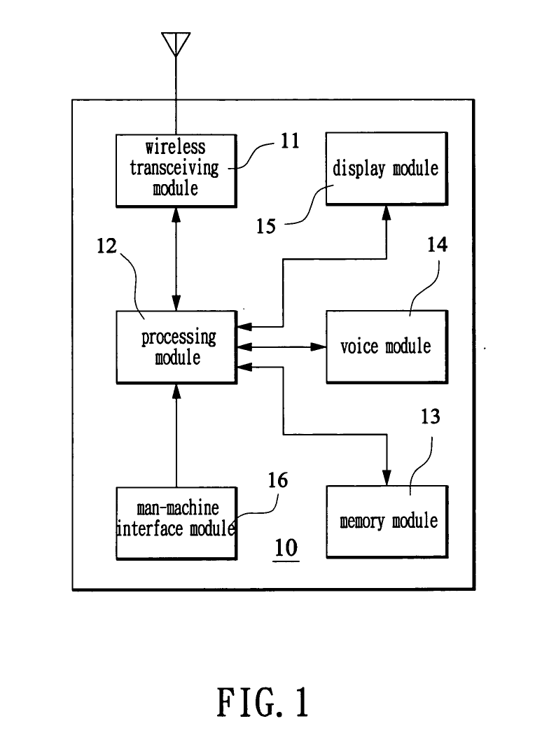

As shown in FIG. 1, several sets of religious prayers voices or several sets of religious texts (e.g., the Bible, the Buddhist Scripture, the Koran and so on) are stored in a mobile phone 10 to help adherents of a religions. The mobile phone 10 at least comprises a wireless transceiving module 11, a processing module 12, a memory module 13, a voice module 14, a display module 15 and a man-machine interface (MMI) module 16. The wireless transceiving module 11 is electrically connected to the processing module 12, and can transmit or receive wireless communication carriers of the mobile phone for voice transmission.

The memory module 13 is electrically connected to the processing module 12. A plurality of prayer voice data or a plurality of religious text data are stored in the memory module 13. The memory module 13 can be a read-only memory (ROM) with the prayer voice data or the religious text data burned therein. The memory module 13 can also be a flash memory so that a user can download the prayer voice data or the religious text data via network and then store into the memory module 13 himself.

The voice module 14 is electrically connected to the processing module 12, and has a sound device like a loudspeaker. The processing module 12 can be set to retrieve the prayer voice data in the memory module 13 and send the same to the voice module 14 for playing. The display module 14 is also electrically connected to the processing module 12. The display module 14 has a display like an LCD display. The processing module 12 can be set to retrieve the religious text data in the memory module 13 and send the same to the display module 15 for display.

The MMI module 16 is the interface between the user and the mobile phone. The MMI module 16 is electrically connected to the processing module 12. The MMI module 16 has an operation menu having a religious prayers item in addition to original items of the mobile phone. The user can use the MMI module 16 to set the processing module 12 to play any prayer voice data or display any religious text data.

A telephone service interrupt value is set in the religious prayers item. The telephone service interrupt value includes an “interruptible” value and a “uninterruptible” value. If the mobile phone has an incoming call when the processing module 12 is playing the prayer voice data, the “interruptible” value controls the processing module 12 to stop playing for answering the incoming call, while the “uninterruptible” value controls the processing module 12 to reject the incoming call and continues playing the prayer voice data.

Further, a religious prayers ring tone item can be added to the operation menu of the MMI module 16. The processing module 12 can be set to play the prayer voice data as the ring tone when the mobile phone has an incoming call.

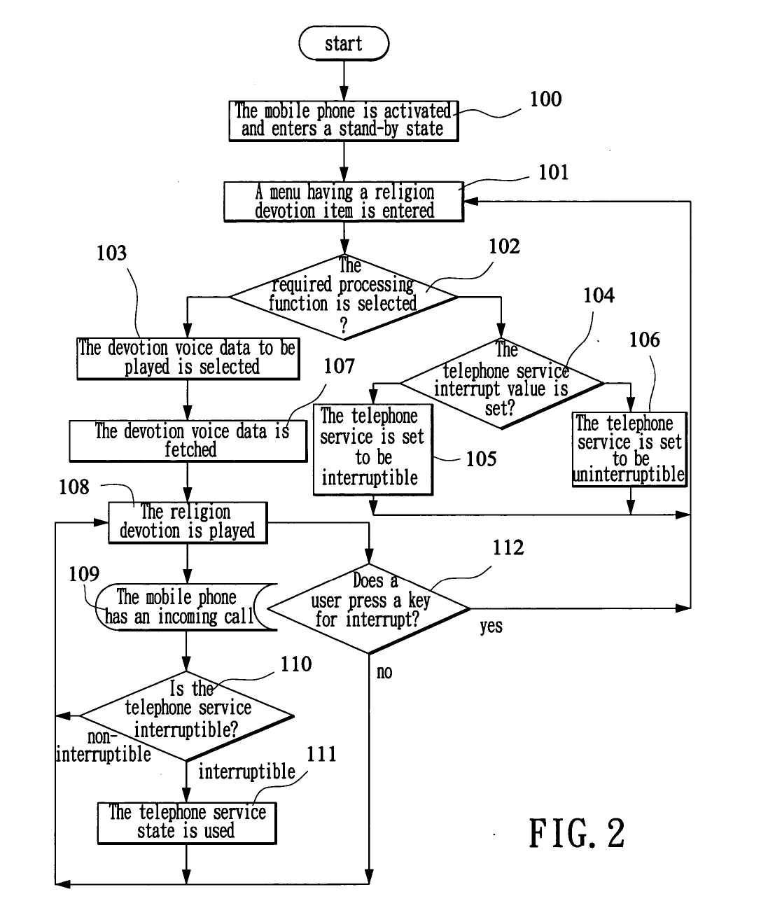

FIG. 2 is a flowchart of playing a religious prayers for a mobile phone according to a first embodiment of the present invention. First, the mobile phone is activated and enters a stand-by state (Step 100). The user then uses the MMI module 16 to enter the operation menu having a religious prayers item (Step 101). The required processing function is selected (Step 102). Speaking more clearly, the prayer voice data to be played is selected (Step 103), or a telephone service interrupt value is set (Step 104).

The telephone service interrupt value includes an “interruptible” value (Step 105) and a “uninterruptible” value (Step 106). If the mobile phone has an incoming call when the processing module 12 is playing the prayer voice data, the “interruptible” value controls the processing module 12 to stop playing for answering the incoming call, while the “uninterruptible” value controls the processing module 12 to reject the incoming call and continues playing the prayer voice data. The default value of the telephone service interrupt value is “interruptible”. The “uninterruptible” value is mainly used to avoid breaking into a religion ceremony when the mobile phone has an incoming call. When the telephone service interrupt value is set, the menu having the religious prayers item is entered (Step 101).

After the prayer voice data to be played is selected (Step 103), the processing module 12 will retrieve the selected prayer voice data (Step 107) and send it to the voice module 14 for playing (Step 108). During playing, if the mobile phone has an incoming call (Step 109), whether the playing is to be interrupted is determined according to the telephone service interrupt value (Step 110). If the set value is “interruptible”, a telephone service state is entered (Step 111). If the set value is “uninterruptible”, the voice module 14 continues playing the prayer voice data (Step 108).

During playing (Step 108), it is only necessary for the user to press an interrupt key if the playing is to be interrupted or stopped. Therefore, whether the interrupt key has been pressed is determined (Step 112). The playing of the prayer voice data is interrupted and the menu having the religious prayers item is entered (Step 101) if the answer is yes; otherwise, the voice module 14 continues playing the prayer voice data (Step 108).

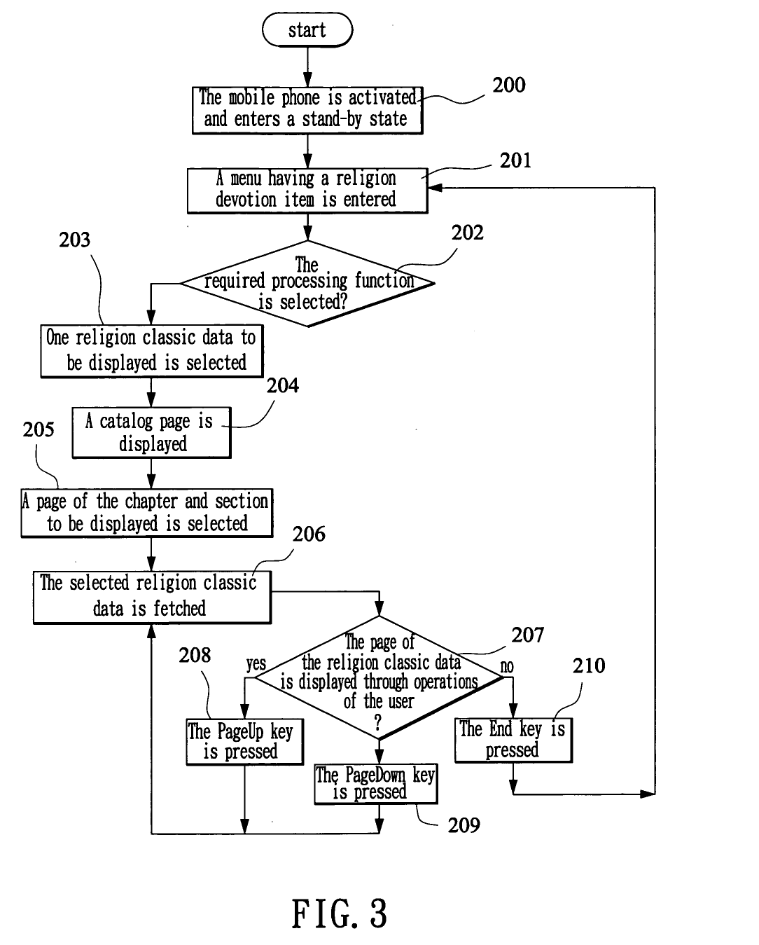

FIG. 3 is a flowchart of displaying religious prayers for a mobile phone according to a second embodiment of the present invention. First, the mobile phone is activated and enters a stand-by state (Step 200). The user then uses the MMI module 16 to enter the operation menu having a religious prayers item (Step 201). The required processing function is selected (Step 202). Speaking more clearly, the religious text data to be displayed is selected (Step 203), or a telephone service interrupt value is set (Step 104).

Step 104 is the same as in the first embodiment and thus is not further described. After the religious text data to be displayed is selected (Step 203), the display module 15 displays a catalog page (Step 204). A page of the chapter and section to be displayed is selected (Step 205). The selected religious text data is retrieved from the memory module 13 (Step 206). Next, the page of the religious text data is displayed through operations of the user (Step 207).

The operations in Step 207 include the operations of a PageUp key (Step 208), a PageDown key (Step 209) and an End key (Step 210). If the PageDown key is pressed, the religious text data of the next page is retrieved (Step 208). If the PageUp key is pressed, the religious text data of the previous page is retrieved (Step 209). If the End key is pressed, display of the religious text data is terminated, and the menu having the religious prayers item is entered (Step 201).

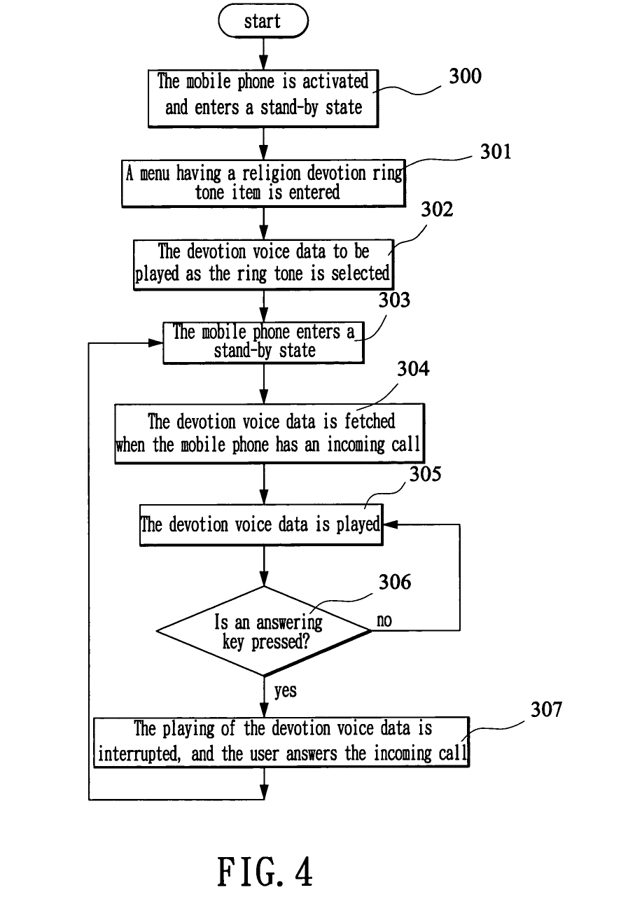

FIG. 4 is a flowchart of providing religious prayers ring tone for a mobile phone according to a third embodiment of the present invention. First, the mobile phone is activated and enters a stand-by state (Step 300). The user then uses the MMI module 16 to enter the operation menu having a religious prayers ring tone item (Step 301). One prayer voice data to be played as the ring tone is selected (Step 302). The mobile phone enters a stand-by state (Step 303). The selected prayer voice data is retrieved when the mobile phone has an incoming call (Step 304). The prayer voice data is played (Step 305). Next, whether an answering key is pressed is determined (Step 306). The playing of the prayer voice data is interrupted and the user answers the incoming call if the answer is yes (Step 307); otherwise, the voice module 14 continues playing the prayer voice data (Step 305) until the incoming call stops.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A mobile phone providing religious prayers, at least comprising:
a memory module storing at least one set of prayer voice data;
a voice module used to play said set of prayer voice data; and
a processing module electrically connected to said memory module and said voice module and used to retrieve said set of prayer voice data in said memory module to send said set of prayer voice data to said voice module for playback.

2. The mobile phone as claimed in claim 1, further comprising a man-machine interface module electrically connected to said processing module and having an operation menu with a religious prayers item, said man-machine interface being used to set said processing module to play said set of prayer voice data.

3. The mobile phone as claimed in claim 1, wherein a telephone service interrupt value is set in said religious prayers item of said man-machine interface module.

4. The mobile phone as claimed in claim 3, wherein said telephone service interrupt value includes an “interruptible” value and a “uninterruptible” value, and if said mobile phone has an incoming call when said processing module is playing said set of prayer voice data, said “interruptible” value controls said processing module to stop playing for answering the incoming call, while said “uninterruptible” value controls said processing module to reject the incoming call and continues playing said set of prayer voice data.

5. The mobile phone as claimed in claim 2, wherein a prayers ring tone item is added to said operation menu of said man-machine interface module to set said processing module to play said set of prayer voice data as the ring tone when said mobile phone has an incoming call.

6. The mobile phone as claimed in claim 1, further comprising a display module electrically connected to said processing module for displaying religious text data, said religious text data being stored in said memory module, said processing module being used to retrieve said religious text data and send said religious text data to said display module for display.

7. The mobile phone as claimed in claim 1, wherein said memory module is a read-only memory or a flash memory.

8. A method of playing religious prayers for a mobile phone, at least comprising the steps of:
entering a menu having a religious prayers item;
selecting at least one set of prayer voice data for playing;
retrieving said set of prayer voice data; and
playing said set of prayer voice data.

9. The method as claimed in claim 8, wherein said step of entering a menu having a religious prayers item further comprises a step of setting a telephone service interrupt value.

10. The method as claimed in claim 9, wherein said telephone service interrupt value includes an “interruptible” value and a “uninterruptible” value, and if said mobile phone has an incoming call when said processing module is playing said set of prayer voice data, said “interruptible” value controls said processing module to stop playing for answering the incoming call, while said “uninterruptible” value controls said processing module to reject the incoming call and continues playing said set of prayer voice data.

11. The method as claimed in claim 8, after said step of playing said prayer voice data further comprising the steps of:
determining whether an interrupt key has been pressed; and
stopping playing said set of prayer voice data if an answer is yes; or
continuing playing said set of prayer voice data if the answer is no.

12. A method of displaying religious prayers for a mobile phone, at least comprising the steps of:
entering a menu having a religious prayers item;
selecting at least one set of religious text data for display;
retrieving said set of religious text data; and
displaying said set of religious text data through operations of a user.

13. The method as claimed in claim 12, further comprising a step of setting a telephone service interrupt value after said step of entering a menu having a religious prayers item.

14. The method as claimed in claim 13, wherein said telephone service interrupt value includes an “interruptible” value and a “uninterruptible” value, wherein if said mobile phone has an incoming call when said processing module is playing said set of prayer voice data, said “interruptible” value controls said processing module to stop playing for answering the incoming call, while said “uninterruptible” value controls said processing module to reject the incoming call and continues playing said set of prayer voice data.

15. The method as claimed in claim 12, before said step of retrieving said set of religious text data further comprising the steps of:
displaying a catalog page of said set of religious text data; and
selecting a page of the chapter and section to be displayed.

16. The method as claimed in claim 12, wherein said step of displaying said set of religious text data through operations of a user further comprises the steps of:
determining whether a PageDown key has been pressed and retrieving said set of religious text data of a next page if an answer is yes;
determining whether a PageUp key has been pressed and retrieving said set of religious text data of the previous page if the answer is yes; and
determining whether an End key has been pressed and terminating display of said set of religious text data if the answer is yes.

17. A method of providing religious prayers ring tone for a mobile phone, at least comprising the steps of:
entering a menu having a religious prayers ring tone item;
selecting at least one set of prayer voice data for playing;
retrieving said prayer voice data when said mobile phone has an incoming call; and
playing said set of prayer voice data.

18. The method as claimed in claim 17, further comprising a step of entering a stand-by state after said step of playing said set of prayer voice data.

19. The method as claimed in claim 17, after said step of playing said prayer voice data further comprising steps of:
determining whether an answering key has been pressed; and
terminating play of said set of prayer voice data and answering an incoming call if an answer is yes; or continuing playing said set of prayer voice data if the answer is no.
